(19) United States
(12) Patent Application Publication
(10) Pub. No.: US 2019/0033770 A1
(43) Pub. Date: Jan. 31, 2019

(54) IMAGE FORMING APPARATUS

(71) Applicant: KONICA MINOLTA, INC., Tokyo (JP)

(72) Inventors: Yasuo SHIOKAWA, Tokyo (JP); Yoshiteru KAWAKAMI, Tokyo (JP); Takahiro OKUBO, Yokohama-shi (JP)

(73) Assignee: KONICA MINOLTA, INC., Tokyo (JP)

(21) Appl. No.: 16/048,824

(22) Filed: Jul. 30, 2018

(30) Foreign Application Priority Data
Jul. 31, 2017 (JP) 2017-147402
Jul. 31, 2017 (JP) 2017-147404
Aug. 1, 2017 (JP) 2017-148799

(51) Int. Cl. G03G 15/00

(52) U.S. Cl. CPC G03G 15/6555; G03G 15/6579

(57) ABSTRACT

An image forming apparatus conveys a sheet to a transferring position of an image of a transferrer and transfers the image onto the sheet. The Apparatus includes a swing roller, a detector and a hardware processor. The swing roller includes a pair of rollers which conveys the conveyed sheet toward the transferrer. The detector is disposed in a second side path at a side facing an image side of the sheet to detect a position of a side end of the sheet and image information of the image transferred on the sheet. The second side path is provided to form an image on a back side of the sheet or to overlay an image on a front side of the sheet. The hardware processor swings the swing roller based on a detection result of the detector and predetermined swing control information.

### BACKGROUND

### 1. Technological Field

The present invention relates to an image forming apparatus.

### 2. Description of the Related Art

In recent years, multifunctional image forming apparatuses that combine the functions of printer, scanner, copier, fax and the like have been widely used. When an image is formed in an image forming apparatus, a sheet is conveyed from a sheet feeder or a flipping path to a transferrer. In this process, the sheet is sometimes misaligned in the direction perpendicular to the conveyance direction (hereinafter also referred to as the sheet width direction). When an image is formed on such a misaligned sheet, the image is formed offset from an originally-intended correct position of the sheet.

To precisely align an image with a sheet in consideration of such misalignment of the sheet, a resist swinging correction has been performed, which involves nipping the sheet with a resist roller and swinging it in the sheet width direction to correct the misalignment of the sheet.

For example, JP 2013-91563A discloses an image forming apparatus that includes a resist roller disposed in the upstream of an image forming site and a line sensor disposed in the downstream of the resist roller and in the upstream of a secondary transfer roller. The image forming apparatus corrects misalignment of the sheet by swinging the sheet in the sheet width direction according to the amount of misalignment of the sheet detected by the line sensor.

However, the configuration of techniques in the prior art such as JP 2013-91563A is such that a line sensor is disposed in the downstream of a resist roller and in the upstream of a secondary transfer roller. When another image is further formed on the back side of the sheet or overlaid on the front side of the sheet after fixation, such techniques cannot be used for detecting misalignment of the sheet from the image position that is due to sub-scanning bow of the sheet, which is a curvature in the middle in the conveyance direction (sub-scanning direction) of the sheet caused by misalignment of conveyance rollers in a dedicated path (flipping path or the like) or the difference in roller diameter of a conveyance roller between the one side and the other side thereof. That is, when another image is formed on the back side or overlaid on the front side of the sheet, misalignment between the sheet and the image position due to sub-scanning bow cannot be corrected with high precision. This may sometimes result in an incorrect image position on the sheet.

### SUMMARY

The present invention has been made in view of the above-described circumstance, and an object thereof is to reduce misalignment of the image position with the sheet due to sub-scanning bow.

To achieve at least one of the abovementioned objects, according to an aspect of the present invention, an image forming apparatus which conveys a sheet to a transferring position of an image of a transferrer and transfers the image onto the sheet includes:
a swing roller including a pair of rollers which conveys the conveyed sheet toward the transferrer;
a detector which is disposed in a second side path at a side facing an image side of the sheet to detect a position of a side end of the sheet and image information of the image transferred on the sheet, in which the second side path is provided to form an image on a back side of the sheet or to overlay an image on a front side of the sheet; and
a hardware processor which swings the swing roller based on a detection result of the detector and predetermined swing control information.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention, and wherein:

FIG. 1 is a schematic configuration view of an image forming apparatus according to a first embodiment;

FIG. 2 illustrates a sheet swing operation of a resist roller;

FIG. 3 is a view from below of an example configuration in which a position sensor is disposed in the upstream of a flipping roller;

FIG. 4 is a schematic block diagram of the control configuration of the image forming apparatus according to the first embodiment;

FIG. 5 is a flowchart of swing control processing that is performed in the first embodiment;

FIG. 6 illustrates an example of data stored in a swing control table;

FIG. 7 is a schematic block diagram of the control configuration of an image forming apparatus according to a second embodiment;

FIG. 8 is a flowchart of write control processing that is performed in the second embodiment;

FIG. 9 illustrates an example of data stored in a write control table;

FIG. 10 is a schematic configuration view of an image forming apparatus according to a third embodiment;

FIG. 11 is a schematic block diagram of the control configuration of the image forming apparatus according to the third embodiment;

FIG. 12 is a flowchart of swing control processing that is performed in the third embodiment;

FIG. 13 illustrates an example arrangement of a second position sensor according to Variation 1;

FIG. 14 illustrates an example arrangement of the second position sensor according to Variation 2;

FIG. 15 illustrates an example arrangement of the second position sensor according to Variation 3;

FIG. 16 illustrates an example of sub-scanning bow;

FIG. 17 is a schematic configuration view of an image forming apparatus with two position sensors;

FIG. 18 is a schematic configuration view of a variation of a recirculation path; and

FIG. 19 is a schematic configuration view of a variation of the recirculation path.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

### Configuration of Image Forming Apparatus 100

First, the configuration of an image forming apparatus 100 according to a first embodiment will be described.

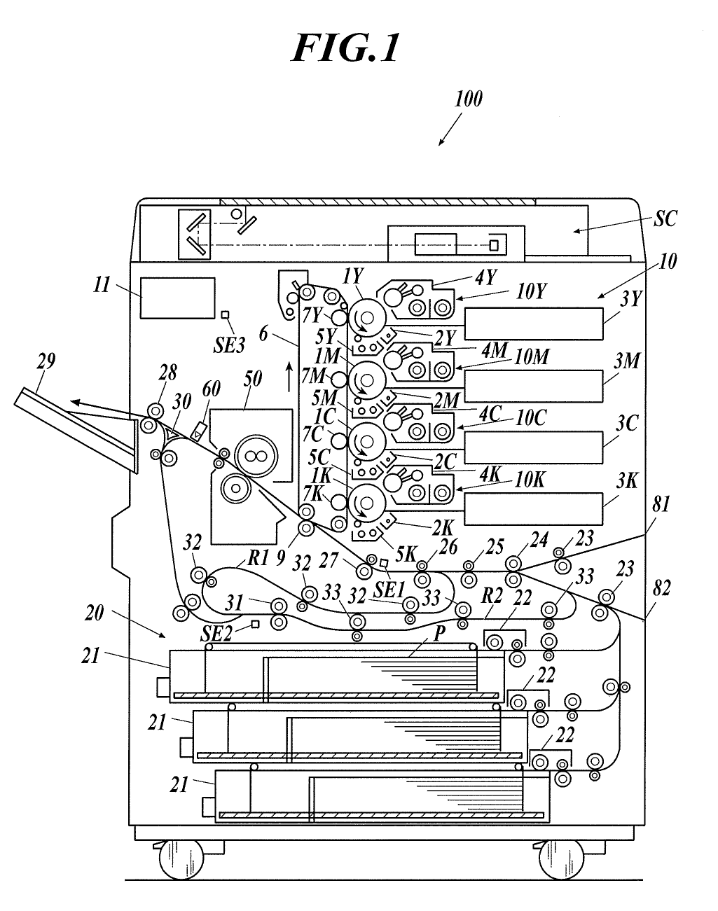

FIG. 1 is a schematic configuration view of the image forming apparatus 100 according to the embodiment. For example, the image forming apparatus 100 is an electrophotographic image forming apparatus such as a copier, specifically a so-called tandem color image forming apparatus that forms a full-color image by using photoreceptors that are vertically arrayed and opposed to a single intermediate transfer belt.

The image forming apparatus 100 mainly includes a scanner SC, an image former 10, a fixer 50, an image reader 60 and a hardware processor 11, which are housed in a single case.

The scanner SC irradiates an image of an original with an optical system of a scanning exposer and reads the reflection light with a line image sensor so as to obtain an image signal. The image signal is subjected to A/D conversion, shedding correction, compression and the like and then input to the hardware processor 11 as image data. The image data to be input to the hardware processor 11 is not limited to data read by the scanner SC and may be data received from a personal computer or another image forming apparatus connected to the image forming apparatus 100 through a communicator 13.

The image former 10 includes four image forming units 10Y, 10M, 10, 10K, an intermediate transfer belt 6, a secondary transfer roller 9 and the like. The image forming units 10Y, 10M, 10C, 10K are constituted by an image forming unit 10Y for forming a yellow (Y) image, an image forming unit 10M for forming a magenta (M) image, an image forming unit 10 C for forming a cyan (C) image and an image forming unit 10K for forming a black (K) image.

The image forming unit 10Y includes a photoreceptor drum 1Y, and a charger 2Y, an optical writer 3Y, a developer 4Y and a drum cleaner 5Y that are disposed around the photoreceptor drum 1Y. Similarly, the image forming units 10M, 10C, 10K include respectively photoreceptor drums 1M, 1C, 1K, chargers 2M, 2C, 2K, optical writers 3M, 3C, 3K, developers 4M, 4C, 4K and drum cleaners 5M, 5C, 5K that are disposed around the respective photoreceptor drums 1M, 1C, 1K.

The chargers 2Y to 2K uniformly charge the surfaces of the photoreceptor drums 1Y to 1K. The optical writers 3Y to 3K scan to expose the surfaces so as to form latent images on the photoreceptor drums 1Y to 1K. The developers 4Y to 4K develop the latent images on the photoreceptor drums 1Y to 1K with toner so as to form visible images. Toner images of the predetermined respective colors of yellow, magenta, cyan and black are thus formed on the photoreceptor drums 1Y to 1K. The toner images formed on the photoreceptor drums 1Y to 1K are sequentially transferred onto a predetermined position of a rotating intermediate transfer belt 6 by primary transfer rollers 7Y, 7M, 7C and 7K.

The toner images thus transferred on the intermediate transfer belt 6 are further transferred to a sheet P by a secondary transfer roller 9 as a transferrer when the sheet P is conveyed at a predetermined timing by the sheet conveyer 20 (described later). The secondary transfer roller 9 is a pressure-contact member that is disposed to be in pressure contact with the intermediate transfer belt 6 so as to form a nipping portion (hereinafter referred to as a “transfer nip”).

The sheet conveyer 20 conveys the sheet P along a conveyance path of the sheet P. The sheet P is stored in a feeding tray 21. The sheet P stored in the feeding tray 21 is taken into the conveyance path by a sheet feeder 22. Alternatively, the sheet P is stored in a feeding tray of an external feeding apparatus (not shown) that is connected to the image forming apparatus 100 through external feeder openings 81, 82 and the like. The sheet P stored in the feeding apparatus is fed from the feeding apparatus to the image forming apparatus 100 through the external feeder openings 81, 82 and taken into the conveyance path. For example, long sheets are fed from the external feeding apparatus to the image forming apparatus 100 through the external feeder openings 81, 82.

In the conveyance path, two or more conveying means for conveying the sheet P are provided in the upstream of the transfer nip. Each of the conveying means is constituted by a pair of rollers that are in pressure contact with each other. A driving mechanism mainly composed of an electric motor rotates at least one of the rollers so as to convey the sheet P. The state of the pairs of rollers of the individual conveying means is switchable between a pressure-contact state and a separated state.

In the embodiment, intermediate conveyance rollers 23 to 25, a loop roller 26 and a resist roller 27 are provided as the conveying means from the upstream to the downstream of the conveyance path of the sheet P. Instead of a pair of rollers, the conveying means may also be constituted by a pair of rotating members selected from a wide variety of combinations, e.g. a pair of belts, a belt and a roller, and the like.

When the sheet P is fed from the feeding tray 21 or a feeding tray of the feeding apparatus, it is conveyed along the conveyance path sequentially by the intermediate conveyance rollers 23 to 25 and a loop roller 26 disposed from the upstream to the downstream of the conveyance path. When a front end of the sheet P approaches the resist roller 27, the sheet P abuts the resist roller 27 in a rotation halt state by being conveyed by the intermediate conveyance rollers 23 to 25 and the loop roller 26. The loop roller 26 then continues rotating for a predetermined time so that the sheet P forms a loop. The loop thus formed corrects skew of the front end of the sheet P (skew correction).

Then, when the resist roller 27 starts to rotate at a predetermined timing in synchronization with the toner image on the intermediate transfer belt 6, the state of the intermediate conveyance rollers 23 to 25 and the loop roller 26 is changed from the pressure-contact state to the separated state. After the state of the intermediate conveyance rollers 23 to 25 and the loop roller 26 is changed to the separated state, the sheet P is conveyed only by the resist roller 27. The resist roller 27 serves as a swing roller to perform a swing operation (described later) while conveying the sheet P. The resist roller 27 conveys the sheet P to the transfer nip between the intermediate transfer belt 6 as an image carrier and the secondary transfer roller 9 as the transferrer.

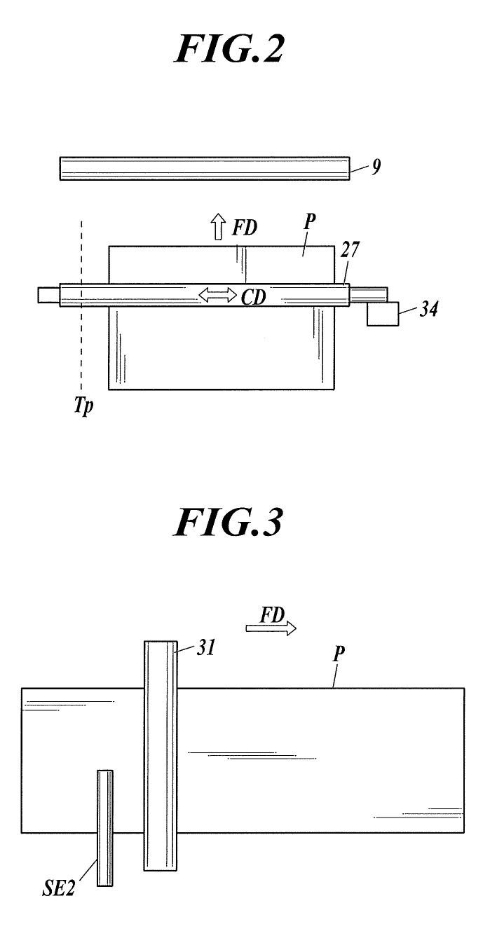

FIG. 2 illustrates the swing operation for the sheet P by the resist roller 27. The resist roller 27 is swingable in the sheet width direction CD (the direction perpendicular to the sheet conveyance direction (sub-scanning direction) FD). A driving mechanism 34 mainly composed of an electric motor is connected to the resist roller 27. The resist roller 27 is driven by the driving mechanism 34 to move the sheet P in the sheet width direction CD from a predetermined home position.

The resist roller 27 can move in the sheet width direction CD while the sheet P is passing through it, so as to move the conveying sheet P in the sheet width direction CD (swing operation). By this operation, the resist roller 27 adjusts the conveying position in the sheet width direction CD of the sheet P so that the sheet P is aligned with the position of the toner image to be transferred. As used herein, the position in the sheet width direction CD in which a side end of the sheet P desirably pass is referred to as a target position Tp. When the side end of the sheet P passes the target position Tp in the sheet width direction CD, the sheet P and the toner image are expected to be in the optimal positional relationship (e.g. a center in the width direction of the sheet P aligns with a center in the width direction of the toner image). The resist roller 27 adjusts the conveying position in the sheet width direction CD of the sheet P so that the side end of the sheet P comes in the target position Tp. The position of the toner image in which the positional relationship between the sheet P and the toner image is optimal is referred to as an optimal image position.

In the conveyance path, a resist sensor SE1 and a position sensor SE2 are provided. The hardware processor 11 controls the operation of the resist roller 27 based on the detection results of the sensors.

The resist sensor SE1 is disposed in the conveyance path between the resist roller 27 and the loop roller 26. The resist sensor SE1 detects arrival of a front end of the sheet P at a detecting position of the resist sensor SE1 (a predetermined distance ahead of the resist roller 27). The detection result of the resist sensor SE1 is used to determine the timing to start rotation of the resist roller 27 and the like.

As illustrated in FIG. 1 and FIG. 3, the position sensor SE2 is disposed in the upstream of a flipping roller 31 in a sheet conveyance direction FD of the conveyance path at the side facing the image side of the sheet P (lower side of the conveyance path). For example, the position sensor SE2 includes a linear image sensor with light receiving elements arrayed in the sheet width direction CD (e.g. a CCD line sensor or the like), an optical system, a light source and the like. The position sensor SE2 is a detector that detects the position in the sheet width direction CD of the side end of the sheet P that has been subjected to fixation by the fixer 50 and that is conveyed to the flipping roller 31. In the embodiment, the position sensor SE2 can read the sheet P from the image side thereof. Accordingly, it can detect the position of the toner image transferred on the sheet P (i.e. where on the sheet P the toner image is formed) as image information. The detection result of the position sensor SE2 is output to the hardware processor 11 and used for determining swing control information for the resist roller 27 in swing control processing and the like.

The fixer 50 performs fixation on the sheet P on which the toner image has been transferred, i.e. the sheet P that is conveyed from the transfer nip. For example, the fixer 50 is constituted by a pair of fixing members (e.g. a pair of rollers) and a heater for heating either or both of the fixing members. The fixer 50 fixes the toner image onto the sheet P by the pressure of the pair of fixing members and the heat of the pair of the fixing members during conveyance of the sheet P.

After fixation by the fixer 50, the sheet P is read by the image reader (ICCU) 60 and thereafter ejected to a catch tray 29 attached on an outer side wall of the case by an ejection roller 28. When another image is formed on the back side of the sheet P or overlaid on the front side of the sheet P, the sheet P on which an image has been formed on the front side is read by the image reader 60 and thereafter convened to the flipping roller 31 disposed in the downstream by the switching gate 30.

When another image is formed on the back side of the sheet P, the flipping roller 31 nips the rear end of the conveyed sheet P and thereafter conveys it backward so as to flip and send the sheet P to a flipping path R1. The flipping path R1 is provided to form an image on the back side of the sheet P. The sheet P thus sent to the flipping path R1 is conveyed by conveying means 32 in the flipping path R1 and returned to the transfer nip through the resist roller 27.

When another image is overlaid on the front side of the sheet P, the flipping roller 31 sends the sheet P directly to a recirculation path R2 without conveying it backward. The recirculation path R2 is provided to overlay another image on the front side of the sheet P. The sheet P that is sent to the recirculation path R2 is conveyed by conveying means (conveyers) 33 in the recirculation path R2 and returned to the transfer nip through the resist roller 27. When the sheet P to be sent to the recirculation path R2 is a long sheet, the conveying means 33 may not be provided in the recirculation path R2 since the flipping roller 31 can convey the sheet P along the recirculation path R2.

The ejection roller 28, the switching gate 30, the flipping roller 31, the conveying means 32 in the flipping path R1 and the conveying means 33 in the recirculation path R2 constitute the above-described sheet conveyer 20. In the embodiment, the path that branches off at the switching gate 30 and rejoins to the original conveyance path (in which an image is formed on the front side (first side) of the sheet P) (i.e. the path that includes the flipping path R1 and the recirculation path R2) is referred to as a “second side path”. Accordingly, even when the sheet P is recirculated so that another image is overlaid on the front side of the sheet P (when no image is formed on the back side (second side) of the sheet P), the path (recirculation path R2) for recirculating the sheet P is also referred to as the second side path. That is, the second side path is provided to form or overlay another image on the back or front side of the sheet P.

For example, the image reader 60 is constituted by a linear image sensor (e.g. a CCD line sensor or the like), an optical system, a light source and the like. The image reader 60 reads the sheet P with the toner image transferred thereon and outputs the read image to the hardware processor 11. In the embodiment, the image reader 60 is capable of measuring the color of the toner image on the sheet P. However, the image reader 60 is not particularly limited and may be constituted by any device that can recognize the area of the sheet P and the area of the toner image. Further, in the embodiment, the image reader 60 is disposed in the downstream of the fixer 50 and ahead of the point at which the switching gate 30 switches the conveyance path. However, the position of the image reader 60 is not particularly limited, and may be disposed anywhere in the downstream of the secondary transfer roller 9 (transfer nip) at which it can read both sides (simultaneously or sequentially) of the sheet P. It should be understood well that the image reader 60 may also be disposed in the downstream of the image forming apparatus 100 as an optional device.

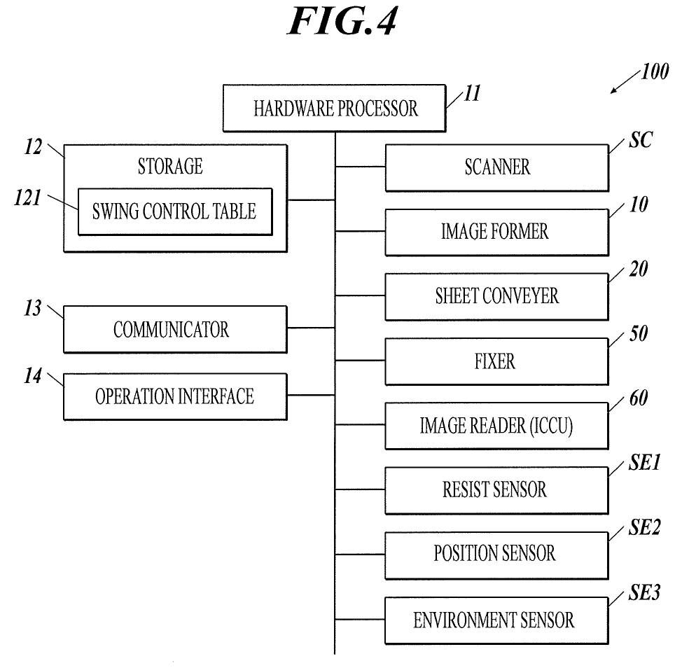

FIG. 4 is a schematic block diagram of the configuration of the image forming apparatus 100 according to the embodiment.

As illustrated in FIG. 4, the hardware processor 11 is connected to a storage 12, the communicator 13, an operation interface 14, the scanner SC, the image former 10, the sheet conveyer 20, the fixer 50, the image reader 60, the resist sensor SE1, the position sensor SE2 and an environment sensor SE3. The hardware processor 11 is constituted by a CPU, a RAM and the like. The CPU of the hardware processor 11 reads out a system program and a variety of processing programs stored in the storage 12, develops them on the RAM and integrally controls the components of the image forming apparatus 100 according to the developed programs. For example, when a job execution command is input through the operation interface 14, the hardware processor 11 executes the job to form a toner image on the sheet P based on image data input from the scanner SC or the communicator 13. Further, when a job execution command is input through the operation interface 14, the hardware processor 11 performs the swing control processing to control the swing of the resist roller 27 during execution of the job.

The storage 12 is constituted by a non-volatile semiconductor memory, an HDD and the like. A variety of programs to be executed by the hardware processor 11 and parameters and data necessary for the components are stored in the storage 12.

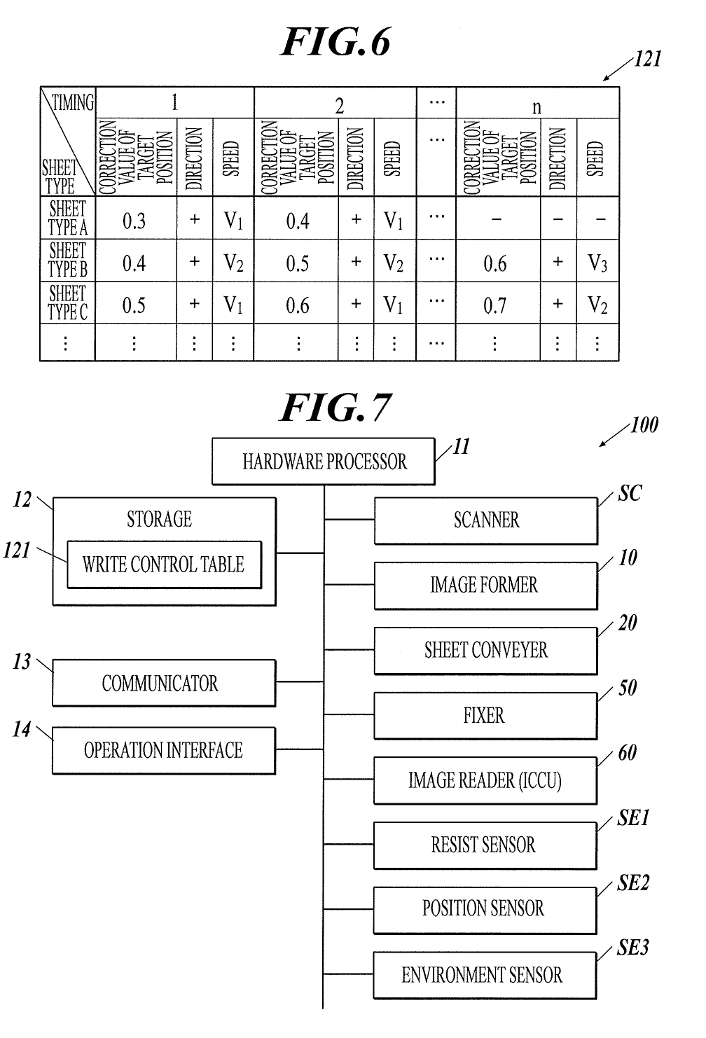

For example, a swing control table 121 (see FIG. 6) is stored in the storage 12.

The communicator 13 includes a variety of interfaces such as an NIC (network interface card), a MODEM (modulator-demodulator) and a USB (universal serial bus). The communicator 13 is provided for connection with an external device.

The operation interface 14 outputs a variety of information set by the user to the hardware processor 11. For example, the operation interface 14 may be constituted by a touch panel on which the user can input operations according to information on a display. Through the operation interface 14, the user can set printing conditions, i.e. the type (e.g. size, sheet quality, basis weight, etc.) of the sheet P, a feeding tray to be used, image density, magnification, simplex/duplex printing and the like. Further, the user can input a job execution command or a command to enter an adjustment mode through the operation interface 14. The hardware processor 11 can control the operation interface 14 to display a variety of information to the user on the operation interface 14.

For example, the environment sensor SE3 includes a temperature sensor, a humidity sensor and the like. The environment sensor SE3 detects the temperature and the humidity inside the case of the image forming apparatus 100 and outputs the detection result to the hardware processor 11.

### Operation of the Image Forming Apparatus 100

Next, the operation of the image forming apparatus 100 according to the first embodiment will be described.

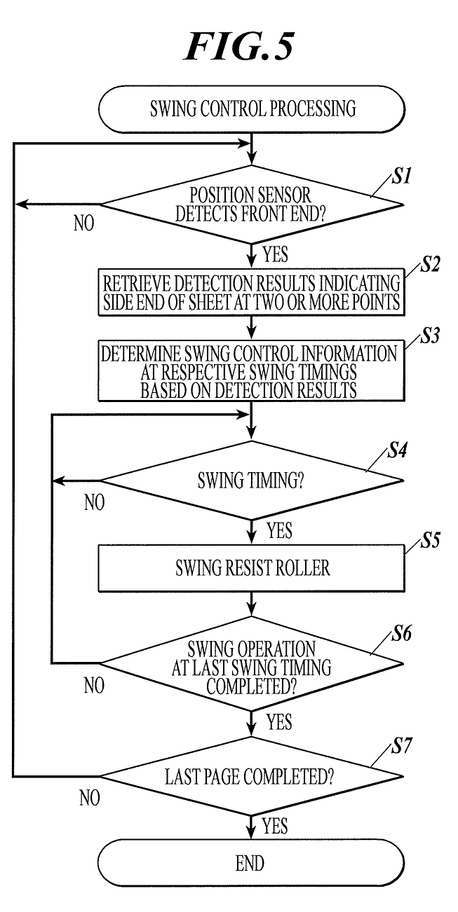

FIG. 5 is a flowchart of the swing control processing for controlling the swing operation of the resist roller 27. The processing in the flowchart is performed by the hardware processor 11 in cooperation with programs stored in the storage 12 according to a job execution command of the user.

First, the hardware processor 11 makes a determination as to whether the position sensor SE2 detects the front end of the sheet P (Step S1).

If the hardware processor 11 determines that the position sensor SE2 detects the front end of the sheet P (Step S1, Yes), it retrieves detection results of the position sensor SE2 that indicate the position of the side end of the sheet P at two or more points (e.g. two points) (Step S2). This allows detection of an error in sheet conveyance that is caused by the conveyance rollers disposed in the second side path.

If the hardware processor 11 determines that the position sensor SE2 does not detect the front end of the sheet P (Step S1, No), it waits until the position sensor SE2 detects the front end of the sheet P.

The positional error of the side end of the sheet P changes depending on sheet conveyance-related conditions (predetermined conditions that affect the sheet conveyance). Accordingly, it is necessary to change the swing control information (a correction value of the target position Tp of the sheet P, the swing direction (+or −) and the swing speed) according to a change of the positional error of the side end of the sheet P with respect to each of the sheet conveyance-related conditions. For example, the sheet conveyance-related conditions include the sheet type and the basis weight of the sheet P, the environment (e.g. temperature and humidity), the sheet size (sheet width and sheet length) and the like. For example, when the sheet type is thin paper, it is necessary to increase the correction value since the sheet P is bowed more easily than a normal paper and a board paper.

In the embodiment, a table of the swing control information with respect to each of the sheet conveyance-related conditions is stored in the storage 12. That is, the swing control information is set according to the sheet conveyance-related conditions. FIG. 6 illustrates an example of the table (swing control table 121) which contains swing control information with respect to each sheet type.

Then, the hardware processor 11 determines the swing control information for controlling the resist roller 27 at predetermined swing timings based on the detection results of the position sensor SE2 and the preset swing control information (swing control table 121) (Step S3).

In the embodiment, the resist roller 27 is controlled to swing at predetermined timings (hereinafter referred to as swing timings), and the swing control table 121 contains the swing control information with respect to each of the swing timings (Timing 1 to Timing n). To write the toner image in the optimal image position of the sheet P with high precision, it is preferred that the swing control table 121 contains the swing control information at the respective swing timings (Timing 1 to Timing n) with respect to each sheet type, each basis weight, each sheet size or each combination thereof.

Since the swing control table 121 as described above is stored in the storage 12, the swing control information can be properly determined according to the conditions.

In the embodiment, the position sensor SE2 is capable of obtaining the image information on the toner image since it is disposed at the side facing the image side of the sheet P. Accordingly, the swing control information for the resist roller 27 may be determined based on the detection results of the position sensor SE2 that indicate the position of the side end of the sheet and the position of the toner image. For example, the distances between the side end of the sheet and the toner image at the respective swing timings may be calculated from the detection results of the position sensor SE2 that indicate the position of the side end of the sheet and the position of the toner image. Then, the differences (offsets) of the calculated distances from the distance between the side end of the sheet and the toner image in the optimal image position are calculated, and the swing control information at the respective swing timings is determined based on the calculated offsets. This allows alignment of the toner image into the optimal image position with high precision.

Then, the hardware processor 11 makes a determination as to whether it is a swing timing of the resist roller 27 (Step S4). As used herein, a swing timing refers to the timing of swinging the resist roller 27. For example, in the embodiment, two or more swing timings are predetermined (e.g. at approximately regular time intervals), such as t1 seconds, t2 seconds . . . after detection of the front end of the sheet P by the position sensor SE2.

If the hardware processor 11 determines that it is the swing timing (Step S4, Yes), it swings the resist roller 27 by using the driving mechanism 34 according to the swing control information at the swing timing that is determined in step S3 (Step S5).

If the hardware processor 11 determines that it is not a swing timing (Step S4, No), it waits until a swing timing.

Then, the hardware processor 11 makes a determination as to whether the swing operation at the last swing timing is completed (Step S6) For example, it makes a determination as to whether the swing operation at the last swing timing is completed based on the size of the sheet P, the time elapsed from the detection of the front end of the sheet P by the position sensor SE2 and the conveyance speed.

If the hardware processor 11 determines that the swing operation at the last swing timing is completed (Step S6, Yes), it makes a determination as to whether the image transfer is completed to the last page (Step S7).

If the hardware processor 11 determines that the swing operation at the last swing timing is not completed yet (Step S6, No), the control returns to Step S4. The hardware processor 11 waits until the next swing timing, and when it is the next swing timing, it repeats the swing operation of the resist roller 27.

Then, if the hardware processor 11 determines that the image transfer is completed to the last page (Step S7, Yes), the swing control processing ends.

If the hardware processor 11 determines that the image transfer is not completed to the last page yet (Step S7, No), the control returns to Step S1.

As described above, the image forming apparatus 100 according to the first embodiment includes the resist roller 27 (swing roller) composed of a pair of rollers that conveys the conveyed sheet further to the secondary transfer roller 9 (transferrer), the position sensor SE2 (detector) that is disposed in the second side path for forming or overlaying another image on the back or front side of the sheet at the side facing the image side of the sheet, to detect the position of the side end of the sheet and the image information on the image transferred on the sheet, and the hardware processor 11 that swings the resist roller 27 according to the detection result of the position sensor SE2 and the predetermined swing control information.

With this configuration, the image forming apparatus 100 according to the first embodiment can adjust the position of the side end of the sheet P by swinging the resist roller 27 based on the offset of the side end of the sheet P from the target position and the offset of the image transferred on the sheet P detected in the second side path. Therefore, misalignment of the toner image with the sheet P due to sub-scanning bow can be reduced at high precision. This is more advantageous for a long sheet that is long in the sheet conveyance direction.

In the image forming apparatus 100 according to the first embodiment, the second side path includes the recirculation path R2 for overlaying another image on the front side of the sheet.

With this configuration, the image forming apparatus 100 according to the first embodiment can adjust the position of the side end of the sheet P even when another image is overlaid on the front side of the sheet P. Therefore, misalignment of the toner image with the sheet P due to sub-scanning bow can be reduced more surely.

In the image forming apparatus 100 according to the first embodiment, the conveying means 33 (conveyers) for conveying a sheet is disposed in the recirculation path R2.

With this configuration, the image forming apparatus 100 according to the first embodiment can convey the sheet P along the recirculation path R2 even when the sheet P is a standard-size sheet. Therefore, it can overlay another image on the front side of the sheet P regardless of the sheet length.

In the image forming apparatus 100 according to the first embodiment, the position sensor SE2 is disposed in the upstream of the flipping roller 31 that guides a sheet to the flipping path R1 for forming an image on the back side of the sheet.

With this configuration, the image forming apparatus 100 according to the first embodiment can detect the position of the side end and the image information of the sheet P after it is flipped by the flipping roller 31. Therefore, the information can be obtained immediately after the sheet passes through a site where a misalignment tends to occur, and misalignment of the toner image with the sheet P due to sub-scanning bow can be reduced more surely.

### Second Embodiment

Next, a second embodiment of the present invention will be described.

The second embodiment is an example in which an image writhing operation of the image forming units 10Y, 10M, 10C, 10K is controlled based on the detection result of a position sensor SE2 and predetermined write control information so that misalignment of an image position with a sheet due to sub-scanning bow is reduced. The same reference sings are denoted to the same components as those in the first embodiment, and the detailed description thereof is omitted.

### Configuration of Image Forming Apparatus 100

First, the configuration of an image forming apparatus 100 according to a second embodiment will be described.

An image former 10 includes four image forming units (image writers) 10Y, 10M, 10, 10K, an intermediate transfer belt 6, a secondary transfer roller 9 and the like. The image forming units 10Y, 10M, 10C, 10K are constituted by an image forming unit 10Y for forming a yellow (Y) image, an image forming unit 10M for forming a magenta (M) image, an image forming unit 10 C for forming a cyan (C) image and an image forming unit 10K for forming a black (K) image.

When a resist roller 27 starts to rotate at a predetermined timing in synchronization with the toner image on an intermediate transfer belt 6, the state of intermediate conveyance rollers 23 to 25 and a loop roller 26 is changed from a pressure-contact state to a separated state. That is, after the intermediate conveyance rollers 23 to 25 and the loop roller 26 are separated, a sheet P is conveyed only by the resist roller 27. The resist roller 27 conveys the sheet P to the transfer nip between the intermediate transfer belt 6 as an image carrier and a secondary transfer roller 9 as the transferrer.

In the conveyance path, a resist sensor SE1 and a position sensor SE2 are disposed. The hardware processor 11 controls the operation of the image forming units 10Y, 10M, 10C and 10K based on the detection results of the sensors.

The position sensor SE2 is disposed in the upstream of a flipping roller 31 in a sheet conveyance direction FD of the conveyance path at the side facing the image side of the sheet P (lower side of the conveyance path). For example, the position sensor SE2 includes a linear image sensor with light receiving elements arrayed in the sheet width direction CD (e.g. a CCD line sensor or the like), an optical system, a light source and the like. The position sensor SE2 is a detector that detects the position in the sheet width direction CD of a side end of the sheet P that has been subjected to fixation by the fixer 50 and that is conveyed to the flipping roller 31. In the embodiment, the position sensor SE2 can read the sheet P from the image side thereof. Accordingly, it can detect the position of the toner image transferred on the sheet P (i.e where on the sheet P the toner image is formed) as image information. The detection result of the position sensor SE2 is output to the hardware processor 11 and used for determining the write control information for the image forming units 10Y, 10M, 10C, 10K.

FIG. 7 is a schematic block diagram of the control configuration of the image forming apparatus 100 according to the second embodiment.

As illustrated in FIG. 7, the hardware processor 11 is connected to a storage 12, a communicator 13, an operation interface 14, a scanner SC, an image former 10, a sheet conveyer 20, a fixer 50, an image reader 60, the resist sensor SE1, the position sensor SE2 and an environment sensor SE3. The hardware processor 11 is constituted by a CPU, a RAM and the like. The CPU of the hardware processor 11 reads out a system program and a variety of processing programs stored in the storage 12, develops them on the RAM and integrally controls the components of the image forming apparatus 100 according to the developed programs. For example, when a job execution command is input through the operation interface 14, the hardware processor 11 executes the job to form a toner image on the sheet P based on image data input from the scanner SC or the communicator 13. Further, when a job execution command is input through the operation interface 14, the hardware processor 11 performs the write control processing to control a writing operation of the image forming units 10Y, 10M, 10C, 10K during execution of the job.

The storage 12 is constituted by a non-volatile semiconductor memory, an HDD and the like. A variety of programs to be executed by the hardware processor 11 and parameters and data necessary for the components are stored in the storage 12.

For example, a write control table 121 (see FIG. 9) is stored in the storage 12.

### Operation of Image Forming Apparatus 100

Next, the operation of the image forming apparatus 100 according to the second embodiment will be described.

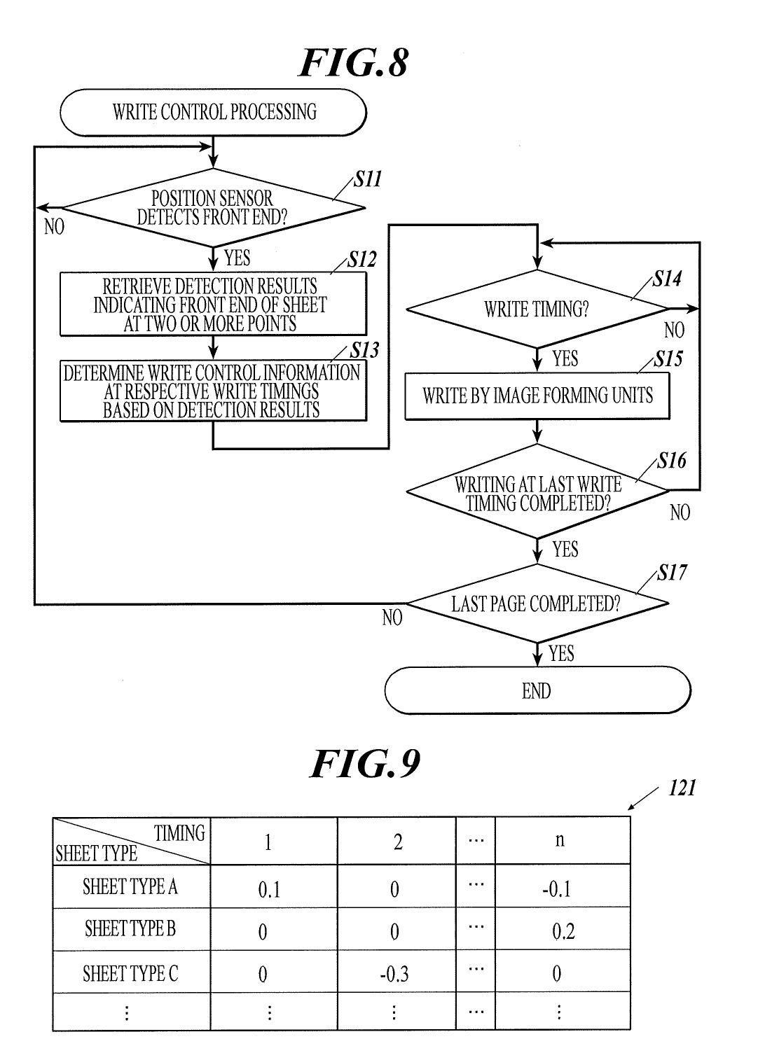

FIG. 8 is a flowchart of processing (write control processing) for shifting an image writing position of the image forming units 10Y, 10M, 10C, 10K. The processing in the flowchart is performed by the hardware processor 11 in cooperation with programs stored in the storage 12 according to a job execution command of the user.

First, the hardware processor 11 makes a determination as to whether the position sensor SE2 detects a front end of the sheet P (Step S11).

If the hardware processor 11 determines that the position sensor SE2 detects the front end of the sheet P (Step S11, Yes), it retrieves detection results of the position sensor SE2 that indicate the position of the side end of the sheet P at two or more points (e.g. two points) (Step S12). This allows detection of an error in sheet conveyance caused by conveyance rollers disposed in a second side path.

If the hardware processor 11 determines that the position sensor SE2 does not detect the front end of the sheet P (Step S11, No), it waits until the position sensor SE2 detects the front end of the sheet P.

The positional error of the side end of the sheet P changes depending on sheet conveyance-related conditions (predetermined conditions that affect the sheet conveyance). Accordingly, it is necessary to change the write control information (the shift amount of the image writing position) with respect to each of the sheet conveyance-related conditions according to the change of the positional error of the side end of the sheet P. For example, the sheet conveyance-related conditions include the sheet type (basis weight, size, sheet quality and the like), the environment (e.g. temperature and humidity), the image forming side (front side/back side) and/or the feeding tray. For example, when the sheet type is thin paper, it is necessary to increase the shift amount since the sheet P is bowed more easily than a normal paper and a board paper.

In the embodiment, a table that contains shift amounts of the image writing position with respect to each of the above-described sheet conveyance-related conditions is stored in the storage 12. That is, the shift amount of the image writing position is set according to the sheet conveyance-related conditions. FIG. 9 illustrates an example of the table (write control table 121) which contains shift amounts of the image writing position with respect to each sheet type.

Then, the hardware processor 11 determines the write control information for the image forming units 10Y, 10M, 10C, 10K at predetermined write timings based on the detection results of the position sensor SE2 and the predetermined write control information (write control table 121) (Step S13).

In the embodiment, the image forming units 10Y, 10M, 10C, 10K are controlled to perform a writing operation at predetermined timings (hereinafter referred to as write timings), and the write control table 121 contains the write control information with respect to each of the write timings (Timing 1 to Timing n). To write the toner image in the optimal image position of the sheet P with high precision, it is preferred that the write control table 121 contains the write control information at the respective write timings (Timing 1 to Timing n) with respect to each sheet type, each environment, each sheet side, each catch tray or each combination thereof.

Since the write control table 121 as described above is stored in the storage 12, the write control information can be properly determined according to the conditions.

FIG. 9 illustrates an example of the write control table 121 that contains offsets from the image writing position (the center in the sheet width direction of the sheet). However, the structure of the write control table 121 is not limited thereto. For example, it may contain shift amounts of the image output position Wc.

In the embodiment, since the position sensor SE2 is disposed on the side facing the image side of the sheet P, it can obtain image information of the toner image. The write control information for the image forming units 10Y, 10M, 10C, 10K may be determined based on detection results of the position sensor SE2 that indicate the position of the side end of the sheet and the position of the toner image. For example, the distances between the side end of the sheet and the toner image at the respective write timings may be calculated from the detection results of the position sensor SE2 that indicate the position of the side end of the sheet and the position of the toner image. Then, the differences (offsets) of the calculated distances from the distance between the side end of the sheet and the toner image in the optimal image position are calculated, and the write control information at the respective write timings is determined based on the calculated offsets. This allows alignment of the toner image into the optimal image position with high precision.

Then, the hardware processor 11 makes a determination as to whether it is a write timing of the image forming units 10Y, 10M, 10C, 10K (Step S14). For example, in the embodiment, two or more write timings are predetermined (e.g. at approximately regular time intervals), such as t1 seconds, t2 seconds . . . after detection of the front end of the sheet P by the position sensor SE2.

If the hardware processor 11 determines that it is the write timing (Step S14, Yes), it controls the image forming units 10Y, 10M, 10C, 10K to perform a writing operation based on the write control information at the write timing determined in Step S13 (Step S15).

If the hardware processor 11 determines that it is not a write timing (Step S14, No), it waits until a write timing.

Then, the hardware processor 11 makes a determination as to whether the writing operation at the last write timing is completed (Step S16) For example, it makes a determination as to whether the writing operation at the last write timing is completed based on the size of the sheet P, the time elapsed from the detection of the front end of the sheet P by the position sensor SE2 and the conveyance speed.

If the hardware processor 11 determines that the writing operation at the last write timing is completed (Step S16, Yes), it makes a determination as to whether the image transfer is completed to the last page (Step S17).

If the hardware processor 11 determines that the writing operation at the last write timing is not completed yet (Step S16, No), the control returns to Step S14. The hardware processor 11 waits until the next write timing, and when it is the next write timing, the hardware processor 11 repeats the writing operation by the image forming units 10Y, 10M, 10C, 10K.

Then, if the hardware processor 11 determines that the image transfer is completed to the last page (Step S17, Yes), the write control processing ends.

If the hardware processor 11 determines that the image transfer is not completed to the last page yet (Step S17, No), the control returns to Step S11.

As described above, the image forming apparatus 100 according to the second embodiment includes the image forming units 10Y, 10M, 10C, 10K (image writers) that writes an image, the position sensor SE2 (detector) that is disposed in the second side path for forming or overlaying another image on the back or front side of the sheet at the side facing the image side of the sheet, to detect the position of the side end of the sheet and the image information of the image transferred on the sheet, and the hardware processor 11 that controls the image forming units 10Y, 10M, 10C, 10K to write the image based on the detection results of the position sensor SE2 and the predetermined write control information.

With this configuration, the image forming apparatus 100 according to the second embodiment can adjust the position of the image on the sheet P by performing the image writing operation of the image forming units 10Y, 10M, 10C, 10K based on the offset of the side end of the sheet P from the target position and the offset of the image transferred on the sheet P detected in the second side path. Therefore, misalignment of the toner image with the sheet P due to sub-scanning bow can be reduced at high precision. This is more advantageous for a long sheet that is long in the sheet conveyance direction.

In the image forming apparatus 100 according to the second embodiment, the second side path includes a recirculation path R2 for overlaying another image on the front side of the sheet.

With this configuration, the image forming apparatus 100 according to the second embodiment can adjust the position of the side end of the sheet P even when another image is overlaid on the front side of the sheet P. Therefore, misalignment of the toner image with the sheet P due to sub-scanning bow can be reduced more surely.

In the image forming apparatus 100 according to the second embodiment, the position sensor SE2 is disposed in the upstream of the flipping roller 31 that guides a sheet to a flipping path R1 for forming an image on the back side of the sheet.

With this configuration, the image forming apparatus 100 according to the second embodiment can detect the position of the side end and the image information of the sheet P after it is flipped by the flipping roller 31. Therefore, the information can be obtained immediately after the sheet passes through a site where a misalignment tends to occur, and the misalignment of the toner image with the sheet P due to sub-scanning bow can be reduced more surely.

### Third Embodiment

Next, a third embodiment of the present invention will be described.

In duplex printing, the sheet is flipped by being conveyed along a flipping path after an image is formed on a first side of a sheet. Thereafter, the sheet is re-fed and conveyed to a transferrer through a resist roller again, and another image transferred onto a second side. However, a problem with techniques in the prior art is that a conveyance error in the flipping path is not considered in swinging the resist roller when the sheet re-fed from the flipping path is conveyed to the transferrer. Therefore, the image on the second side cannot be transferred in a correct position of the sheet with high precision.

In the third embodiment, a position sensor is disposed in the flipping path, and the swing of a resist roller 27 is controlled based on a detection result of the position sensor when the sheet is refed from the flipping path and conveyed to a secondary transfer roller 9. This improves the positional precision of the image to be transferred on the sheet that is re-fed from the flipping path. To simplify the description, the same reference signs are denoted to the same components as those in the first embodiment, and the detailed description thereof is omitted.

### Configuration of Image Forming Apparatus 100

First, an image forming apparatus 100 according to the third embodiment will be described.

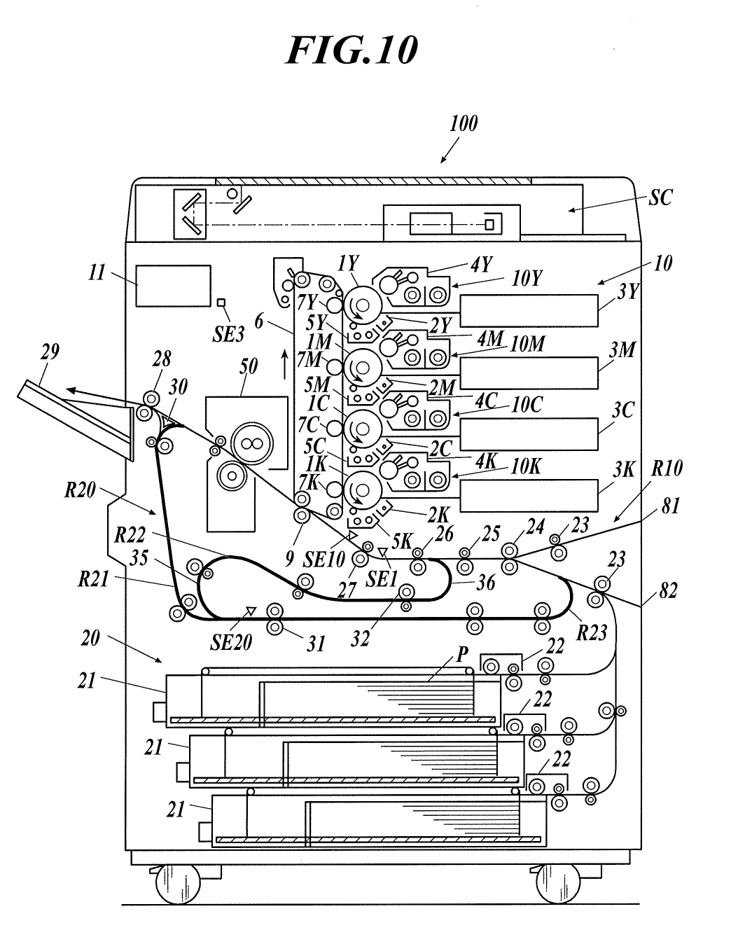

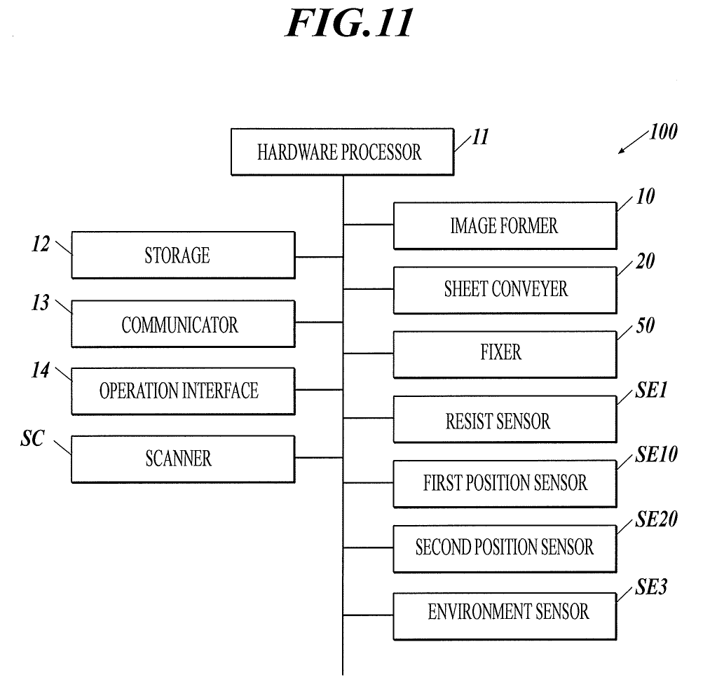

As illustrated in FIG. 10, the image forming apparatus 100 mainly includes a scanner SC, an image former 10, a fixer 50 and a hardware processor 11, which are housed in a single case.

The sheet conveyer 20 conveys a sheet P along a conveyance path of the sheet P. The conveyance path includes an image forming path R10 and a flipping path R20. The image forming path R10 is a conveyance path for conveying the sheet P to a secondary transfer roller 9 and the fixer 50. The flipping path R20 branches off from the image forming path R10 in the downstream of the fixer 50. The flipping path R20 is a conveyance path for flipping the sheet P with an image on a first side (front side) and re-feeding it to the image forming path R10. In FIG. 10, the image forming path R10 is illustrated by a thin line, and the flipping path R20 is illustrated by a bold line.

In each of the conveyance paths, conveying means for conveying the sheet P is disposed. Each of the conveying means is constituted by a pair of rollers that are in pressure contact with each other. A driving mechanism mainly composed of an electric motor rotates at least one of the rollers so as to convey the sheet P.

The state of the pairs of rollers of the individual conveying means is switchable between a pressure-contact state and a separated state.

Instead of a pair of rollers, the conveying means may also be constituted by a pair of rotating members selected from a wide variety of combinations, e.g. a pair of belts, a belt and a roller, and the like.

Between a resist roller 27 and a secondary transfer roller 9, a first position sensor SE10 is provided. For example, the first position sensor SE10 includes a linear image sensor with light receiving elements arrayed in a sheet width direction CD (e.g. a CCD line sensor or the like), an optical system, a light source and the like. The first position sensor SE10 detects the position in the sheet width direction CD of a side end of the sheet P. The detection result of the first position sensor SE10 is output to the hardware processor 11 and used for determining swing control information for the resist roller 27 and the like that is used in the swing operation when an image is formed on the first side.

The flipping path R20 includes a first path R21, a second path R22 and a joining path R23.

The first path R21 branches off from the image forming path R10, and a flipping roller 31 is disposed therein. The first path R21 is provided to change the conveyance direction of the sheet P toward the second path R22. The sheet P sent from the image forming path R10 is conveyed in the same direction (forward direction) by the flipping roller 31, and thereafter the flipping roller 31 rotates in a reverse direction to change the conveyance direction toward the second path R22.

The second path R22 includes bent portions 35, 36. The second path R22 is provided to flip the sheet P and to re-feed it to the image forming path R10 with the second side up.

The joining path R23 is provided to rejoin the first path R21 to the image forming path R10.

When another image is formed on a second side of the sheet P, the sheet P with an image formed (transferred and fixed) on the first side is sent to the first path R21 of the flipping path R20 by the switching gate 30 and conveyed to the flipping roller 31 along the first path R21. The flipping roller 31 conveys the sheet P in the same direction (forward direction) to nip the rear end of the sheet P and thereafter rotates in the reverse direction to change the conveyance direction of the sheet P toward the second path R22 to send the sheet P to the second path R22. When the first path R21 is not long enough, e.g. when the sheet P is a long sheet, it is possible to send the sheet P to the second path R22 by bringing the front end of the sheet P to the image forming path R10 through the joining path R23.

The sheet P sent to the second path R22 is conveyed with the second side up and then temporarily with the first side up after passing through the bent portion 35. After being stopped at a conveying means 32, the sheet P is re-fed to the image forming path R10 at a predetermined timing. The sheet P is flipped when passing though the bent portion 36, re-fed to the image forming path R10 with the second side up and conveyed to the transfer nip through the resist roller 27. The ejection roller 28, the switching gate 30, the flipping roller 31 and conveying means for re-feeding the sheet including the conveying means 32 constitute the sheet conveyer 20.

A second position sensor SE20 is provided in the downstream of the flipping roller 31 in the sheet conveyance direction after the flipping roller 31 starts to rotate in the reverse direction. For example, the second position sensor SE20 includes a linear image sensor with light receiving elements arrayed in the sheet width direction CD (e.g. a CCD line sensor or the like), an optical system, a light source and the like. The second position sensor SE20 is a detector that detects the position in the sheet width direction CD of a side end of the sheet P. Since the second position sensor SE20 is disposed at the side facing the image side of the sheet P, it can also detect the position of the toner image on the sheet P. The detection result of the second position sensor SE20 is output to the hardware processor 11 and used for determining swing control information for controlling the swing operation of the resist roller 27 when the sheet P is re-fed.

After fixation by the fixer 50, the sheet P is ejected to a catch tray 29 attached on an outer side wall of the case by an ejection roller 28. When another image is formed on the second side of the sheet P, the sheet P with an image on the first side is sent to the flipping path R20 by the switching gate 30.

As illustrated in FIG. 11, the hardware processor 11 is connected to a storage 12, a communicator 13, an operation interface 14, a scanner SC, an image former 10, a sheet conveyer 20, a fixer 50, a resist sensor SE1, the first position sensor SE10, the second position sensor SE20, an environment sensor SE3 and the like. The hardware processor 11 is constituted by a CPU, a RAM and the like. The CPU of the hardware processor 11 reads out a system program and a variety of processing programs stored in the storage 12, develops them on the RAM and integrally controls the components of the image forming apparatus 100 according to the developed programs. For example, when a job execution command is input through the operation interface 14, the hardware processor 11 executes the job to form a toner image on the sheet P based on image data input from the scanner SC or the communicator 13. Further, when a duplex print job execution command is input through the operation interface 14, the hardware processor 11 performs the swing control processing (described below) to control the swing of the resist roller 27 during execution of the job.

### Operation of Image Forming Apparatus 100

Next, the operation of the image forming apparatus 100 according to the third embodiment will be described.

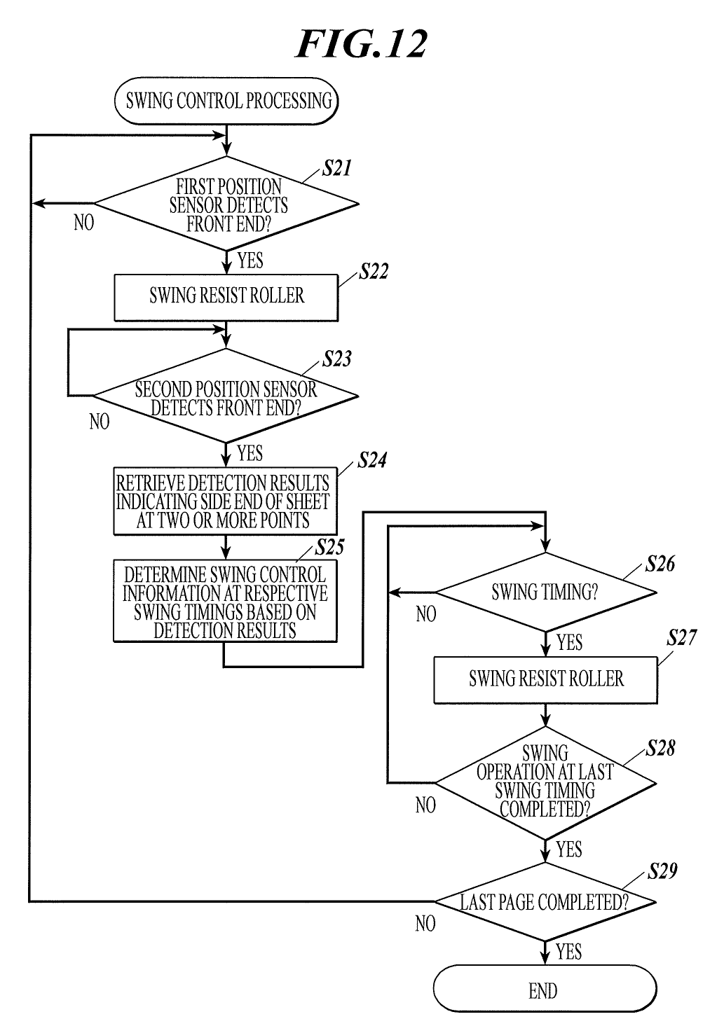

FIG. 12 is a flowchart of the swing control processing for controlling the swing operation of the resist roller 27. The processing in the flowchart is performed by the hardware processor 11 in cooperation with programs stored in the storage 12 according to a duplex print job execution command of the user. For example, in the embodiment, after an image is formed on the first side of the sheet P, another image is successively formed on the second side of the sheet P.

After the job is started, the hardware processor 11 waits until the first position sensor SE10 detects the front end of the sheet P (Step S21).

When the first position sensor SE10 detects the front end of the sheet P (Step S21, Yes), the hardware processor 11 swings the resist roller 27 by means of a driving mechanism 34 based on a detection result of the first position sensor SE10 that indicates the position of the side end of the sheet P (Step S22). For example, the hardware processor 11 calculates the offset of the side end of the sheet detected by the first position sensor SE10 from a target position and determines swing control information (swing amount, swing direction, swing speed) based on the calculated offset. The target position refers to a position in which the side end of the sheet P the sheet P passes when the toner image is expected to be transferred in an optimal image position of the sheet P (e.g. a position in which a center in the width direction of the sheet P aligns with a center in the width direction of the toner image). The hardware processor 11 swings the resist roller 27 by means of the driving mechanism 34 based on the swing control information thus determined.

Then, the hardware processor 11 waits until the second position sensor SE20 detects the front end of the sheet P after the flipping roller 31 starts to rotate in the reverse direction (Step S23).

When the second position sensor SE20 detects the front end of the sheet P (Step S23, Yes), the hardware processor 11 retrieves detection results of the second position sensor SE20 that indicate the position of the side end of the sheet at two or more points in the sub-scanning direction of the sheet P (Step S24).

Then, the hardware processor 11 determines the swing control information for controlling the resist roller 27 at predetermined swing timings based on the detection results of the second position sensor SE20 (Step S25). The swing timings refer to timings of swinging the resist roller 27. For example, in the embodiment, two or more swing timings are predetermined (e.g. at approximately regular time intervals), such as t1 seconds, t2 seconds . . . after detection of the front end of the sheet P by the position sensor SE20.

For example, in Step S25, the hardware processor 11 retrieves the detection results of the second position sensor SE20 that indicate the position (referred to as X1, X2) of the side end of the sheet at two points in the sub-scanning direction in a front part of the sheet P, and calculates the skew of the sheet P based on the retrieved detection results. The hardware processor 11 calculates offsets of the side end of the sheet from the target position at respective swing timings based on the calculated skew and determines the swing control information (swing amount, swing direction, swing speed) at the respective swing timings based on the calculated offsets.

For example, the skew of the sheet P can be calculated using the following formula.

Skew of sheet P=(Difference between X1 and X2 in sheet width direction)/(Conveying distance between X1 and X2)

For example, the swing amount can be calculated using the following formula.

Swing amount=Offset of side end of sheet from target position×α

Where α is a coefficient. Since conveyance of the sheet P is affected by sheet conveyance-related conditions such as the sheet type and the basis weight of the sheet P, the environment (temperature, humidity and the like) and the sheet size (sheet width, sheet length), it is preferred to change the coefficient cc according to the sheet conveyance-related conditions and the swing timing (i.e. the point in the sub-scanning direction to be swung). It is preferred that the swing speed is increased with an increase of the swing amount.

The second position sensor SE20 may be disposed at either image side or non-image side. When it is disposed at the image side, it can obtain image information of the toner image. Accordingly, the swing control information for the resist roller 27 may be determined based on the position of the side end of the sheet and the position of the toner image detected by the second position sensor SE20. For example, the distance between the side end of the sheet and the toner image and the skew are calculated at two or more points based on the detection results of the second position sensor SE20 that indicate the position of the side end of the sheet and the position of the toner image at the points, and the distances between the side end of the sheet and the toner image at respective swing timings are calculated based on the calculated distances and skews. Then, the differences (offsets) of the calculated distances from the distance between the side end of the sheet and the toner image in an optimal image position are calculated, and the swing control information at the respective swing timings is determined based on the calculated offsets. This allows alignment of the toner image into the optimal image position with high precision.

Then, the hardware processor 11 waits a swing timing of the resist roller 27 (Step S26). When the hardware processor 11 determines that it is the swing timing (Step S26, Yes), the hardware processor 11 swings the resist roller 27 by means of the driving mechanism 34 based on the swing control information at the swing timing determined in Step S25 (Step S27).

Then, the hardware processor 11 makes a determination as to whether a swing operation at the last swing timing is completed (Step S28) For example, it makes a determination as to whether the swing operation at the last swing timing is completed based on the size of the sheet P, the time elapsed from the detection of the front end of the sheet P by the second position sensor SE20 and the conveyance speed.

If the hardware processor 11 determines that the swing operation at the last swing timing is not completed yet (Step S28, No), the control returns to Step S26. The hardware processor 11 waits until the next swing timing, and when it is the next swing timing, it repeats the swing operation of the resist roller 27.

If the hardware processor 11 determines that the swing operation at the last swing timing is completed (Step S28, Yes), it makes a determination as to whether the image transfer is completed to the last page (Step S29).

If the hardware processor 11 determines that the image transfer is not completed to the last page yet (Step S29, No), the control returns to Step S21.

If the hardware processor 11 determines that the image transfer is completed to the last page (Step S29, Yes), the swing control processing ends.

In the image forming apparatus 100 according to the third embodiment, the second position sensor SE20 is disposed in the flipping path R20, and the swing of the resist roller 27 is controlled based on the detection results of the second position sensor SE20 (position of the side end of the sheet and/or the position of the toner image) when the sheet P re-fed from the flipping path R20 is conveyed to the secondary transfer roller 9. With this configuration, the image forming apparatus 100 can correct a conveyance error of the sheet P in the flipping path R20 and thereby improve the positional precision of the image transferred on the second side of the sheet P that is re-fed from the flipping path R20. Particularly in the third embodiment, the second position sensor SE20 is disposed in the downstream of the flipping roller 31 in the sheet conveyance direction after the flipping roller 31 starts to rotate in the reverse direction, and the detection result thereof is fed back to the swing of the resist roller 27. This allows correction of a bow of the sheet P that occurs when the flipping roller 31 switches the conveyance direction and improvement of the positional precision of an image transferred on the second side of the sheet P re-fed from the flipping path R20.

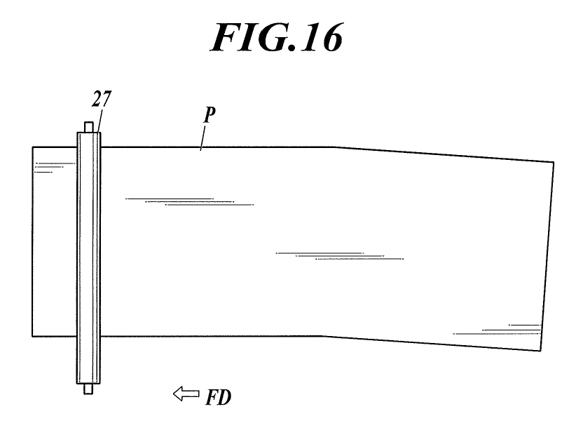

In the third embodiment, the hardware processor 11 calculates offsets of the side end of the sheet at the points in the sub-scanning direction that correspond to the swing timings of the resist roller 27 based on the detection results of the second position sensor SE20, determines the swing control information at the respective swing timings based on the calculated offsets and controls the swing of the resist roller 27 accordingly. That is, the swing can be controlled differently between the front part and the rear part of the sheet, and misalignment of the image position due to sub-scanning bow of the sheet P (which occurs in the middle of the sheet P, see FIG. 16) can therefore be reduced with high precision. This is more advantageous for a long sheet that is long in the sheet conveyance direction.

### Variation 1

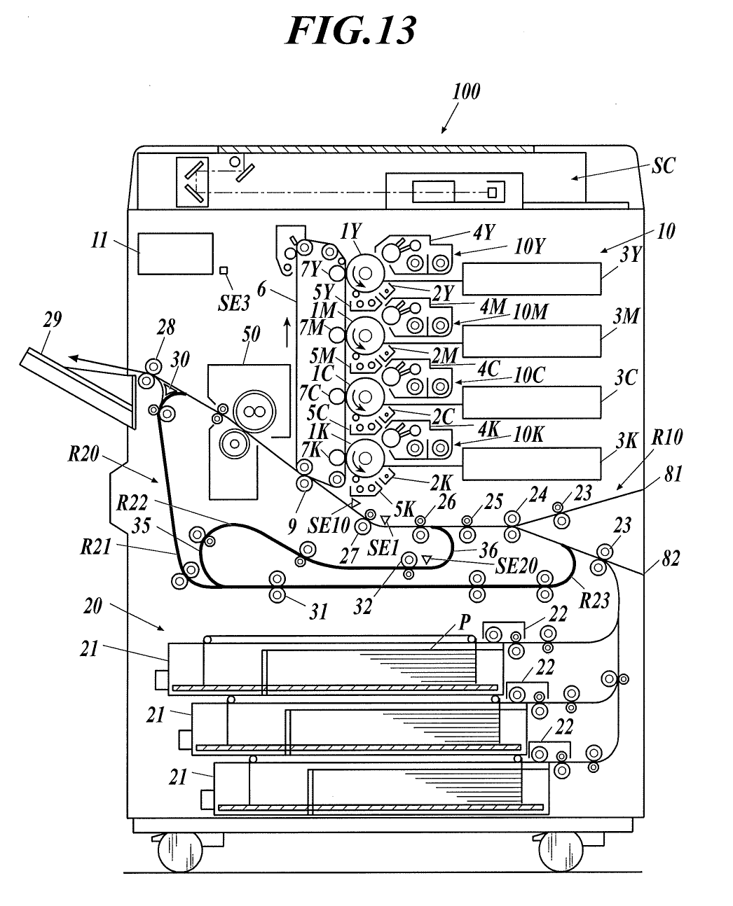

The third embodiment illustrates an example in which the second position sensor SE20 is disposed in the downstream of the flipping roller 31 in the sheet conveyance direction after the flipping roller 31 starts to rotate in the reverse direction. Instead, the second position sensor SE20 may be disposed in the second conveyance path R22 in the downstream of the conveying means 32 as illustrated in FIG. 13. The hardware processor 11 may perform the same swing control processing as illustrated in FIG. 12 to control the swing of the resist roller 27 based on the detection results of the second position sensor SE 20 when the sheet P re-fed from the flipping path R20 is conveyed to the secondary transfer roller 9. This allows correction of a conveyance error that occurs when the conveying means 32 pauses and re-feeds the sheet P and improvement of the positional precision of the image transferred on the second side of the sheet P re-fed from the flipping path R20.

### Variation 2

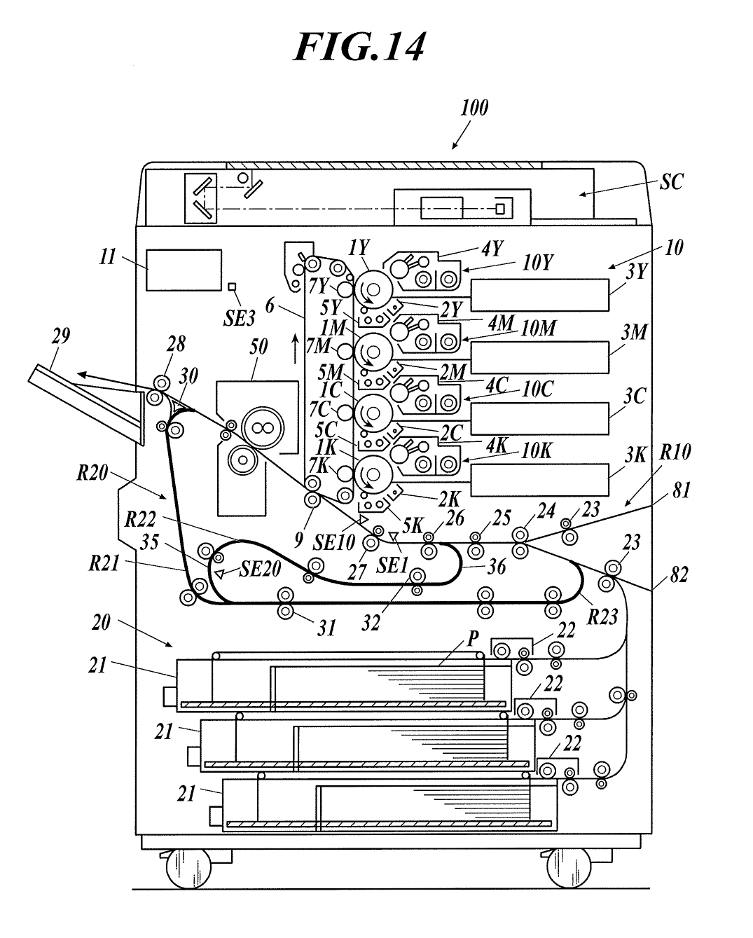

The third embodiment is an example in which the second position sensor SE20 is disposed in the downstream of the flipping roller 31 in the sheet conveyance direction after the flipping roller 31 starts to rotate in the reverse direction. Instead, the second position sensor SE20 may be disposed at the bent portion 35 (or in the downstream of the bent portion 35) of the second path R22 as illustrated in FIG. 14. The hardware processor 11 may perform the same swing control processing as illustrated in FIG. 12 to control the swing of the resist roller 27 based on the detection results of the second position sensor SE 20 when the sheet P re-fed from the flipping path R2 is conveyed to the secondary transfer roller 9. This allows correction of a conveyance error that occurs when the sheet P passes the bent portion 35 and improvement of the positional precision of the image transferred on the second side of the sheet P re-fed from the flipping path R20.

Since the sheet P passes almost at the same position of the bent portion along a guide, the second position sensor SE20 disposed at the bent portion 35 can detect the side end of the sheet precisely and output detection results with less deviation. Further, the second position sensor SE20 disposed in the downstream of the bent portion 35 can detect the side end of the sheet after the bow of the sheet P is caused by the bent portion 35, and the detection results can be fed back to the swing control of the resist roller 27.

In a small image forming apparatus 100 that has a bent portion with a large curvature, second position sensors SE20 may be disposed both before and after the bent portion 35. This allows more accurate detection of the offset of the side end of the sheet P when the sheet P passes through the bent portion 35. For example, the difference between the offset in the upstream and the offset in the downstream of the bent portion 35 corresponds to the error that occurs when the sheet P passes through the bent portion 35. Accordingly, the hardware processor 11 determines the swing control information and swings the resist roller 27 so as to cancel the error.

### Variation 3

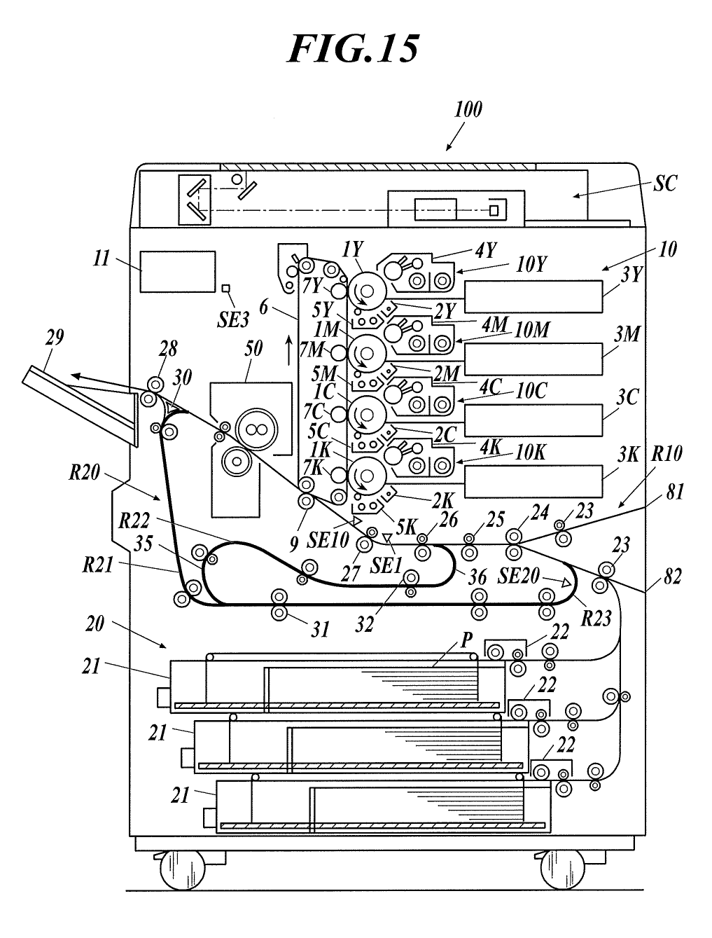

The third embodiment is an example in which the second position sensor SE20 is disposed in the downstream of the flipping roller 31 in the sheet conveyance direction after the flipping roller 31 starts to rotate in the reverse direction. Instead, the second position sensor SE20 may be disposed in the joining path R23 as illustrated in FIG. 15. The hardware processor 11 may perform the same swing control processing as illustrated in FIG. 12 to control the swing of the resist roller 27 based on the detection results of the second position sensor SE 20 when the sheet P re-fed from the flipping path R20 is conveyed to the secondary transfer roller 9. When the sheet P is a long sheet, this allows correction of a conveyance error that occurs in the rear part of the sheet P when it is re-fed in the flipping path R20 and improvement of the positional precision of the image transferred on the second side of the sheet P re-fed from the flipping path R20.

When the sheet P is a long sheet, the front end of the sheet P conveyed in the first path R21 in the forward direction may sometimes reach the resist roller 27 through the joining path R23. In such cases, the hardware processor 11 determines the swing control information for controlling the resist roller 27 when the sheet P reaches the resist roller 27 through the joining path R23 based on the detection results of the second position sensor SE20 disposed in the joining path R23 that indicate the side end of the front end of the sheet P. Based on the determined swing control information, the hardware processor 11 controls the swing of the resist roller 27 when the sheet P reaches the resist roller 27 through the joining path R23. This allows correction of a conveyance error that occurs in the front part of the sheet P (rear part after the conveyance direction is changed) before the conveyance direction is changed.

### Variation 4

Two or more second position sensors 20 may be disposed in any of the positions described in the third embodiment and Variation 1 to Variation 3, and the hardware processor 11 may control the swing of the resist roller 27 based on the detection results of the second position sensors SE20 when the sheet P is re-fed for forming an image on the second side. For example, the second position sensors SE20 may detect the side end of the sheet P simultaneously when the sheet P is passing through all second position sensors SE20. The hardware processor 11 may calculate the skew of the sheet P based on the detection results and then calculate the offsets of the side end of the sheet P from the target position at the points corresponding to the respective swing timings based on the calculated skew. The hardware processor 11 may determine the swing control information in the same manner as the third embodiment based on the calculated offset and then control the swing of the resist roller 27 at the respective swing timings when the sheet P is re-fed for forming an image on the second side based on the determined swing control information. This allows correction of a conveyance error of the sheet P in the flipping path R20 and improvement of the positional precision of the image transferred on the second side of the sheet P re-fed from the flipping path R20. The technique of Variation 4 is particularly effective for long sheets since the sheets themselves may sometimes be deformed (bowed) between the front part and the rear part as illustrated in FIG. 16. The first sensor SE10 may be used as one of the second position sensors SE20.

### Variation 5

In the third embodiment and Variation 1 to Variation 4, the swing of the resist roller 27 when the sheet P is re-fed for forming an image on the second side is controlled based on the detection results of the second position sensor SE20. In addition, the correction of the image writing position (the position of images on the photoreceptor drums 1Y to 1K written by the optical writers 3Y to 3K) of the image forming units 10Y, 10M, 10C, 10K may be combined with the control of the swing of the resist roller 27.

For example, the image writing position of the image forming units 10Y, 10M, 10C, 10K may be corrected so that the absolute position of the image on the sheet may be corrected, and subsequently the swing of the resist roller 27 may be controlled so that the positional error of the side end of the sheet P is reduced.

It is possible only to correct the image writing position of the image forming units 10Y, 10M, 10C, 10K based on the detection results of the second position sensor SE20. However, in terms of the precision of correcting the positional misalignment of the toner image with the sheet P, it is preferred either to perform only the swing control of the resist roller 27 or to combine the swing control of the resist roller 27 with the correction of the image writing position. The correction of the image writing position is effective for shifting the entire image in the scanning direction but not for correcting a bow of the sheet that occurs in the middle of the sheet. In contrast, the swing control of the resist roller 27 is effective for correcting the position of the side end of the sheet P at different points in the sub-scanning direction since the swing amount can be changed according to the position in the sub-scanning direction (e.g. between the front part and the rear part). Even when a bow occurs in the middle of the sheet P, it is possible to correct misalignment of the image with the sheet P with higher precision. When the second position sensor SE20 is disposed in the downstream compared to the position of the second position sensor SE20 in FIG. 10, the detection results cannot be fed back at the timing of the image forming units 10Y, 10M, 10C, 10K writing an image. When the positional misalignment of the image with the sheet P is corrected only by the correction of the image writing position, the position of the second position sensor SE20 is limited to that in FIG. 10 and the upstream thereof. However, when the swing of the resist roller 27 is controlled, the position of the second position sensor SE20 is not limited. Accordingly, it is possible to dispose the second position sensor SE20 in a position closer to the resist roller 27 and to feed back the detection results to the swing control of the resist roller 27.

While the present invention is specifically described with some embodiments, the present invention is not limited thereto, and a variety of changes can be made without departing from the features of the present invention.

For example, the above-described embodiments are examples in which the position sensor SE2 is disposed in the vicinity (upstream) of the flipping roller 31 (see FIG. 1, FIG. 3 and the like). However, the position of the position sensor SE2 is not limited thereto. That is, the position sensor SE2 may be disposed anywhere in the second side path at the side facing the image side of the sheet P. For example, it may be disposed in the downstream of the flipping roller 31, in the downstream of the switching gate 30, near the exit of the recirculation path R2 or the like. However, it is preferred to dispose the position sensor SE2 as close to the resist roller 27 as possible since the error of the detection result from the position of the side end of the sheet at the resist roller 27 is reduced. Further, it is also preferred to dispose the position sensor SE2 in the upstream of the flipping roller 31 as far as possible since a sufficient time is secured from detection by the position sensor SE2 to transfer of an image written by the image forming units 10Y, 10M, 10C, 10K by means of the secondary transfer roller 9.

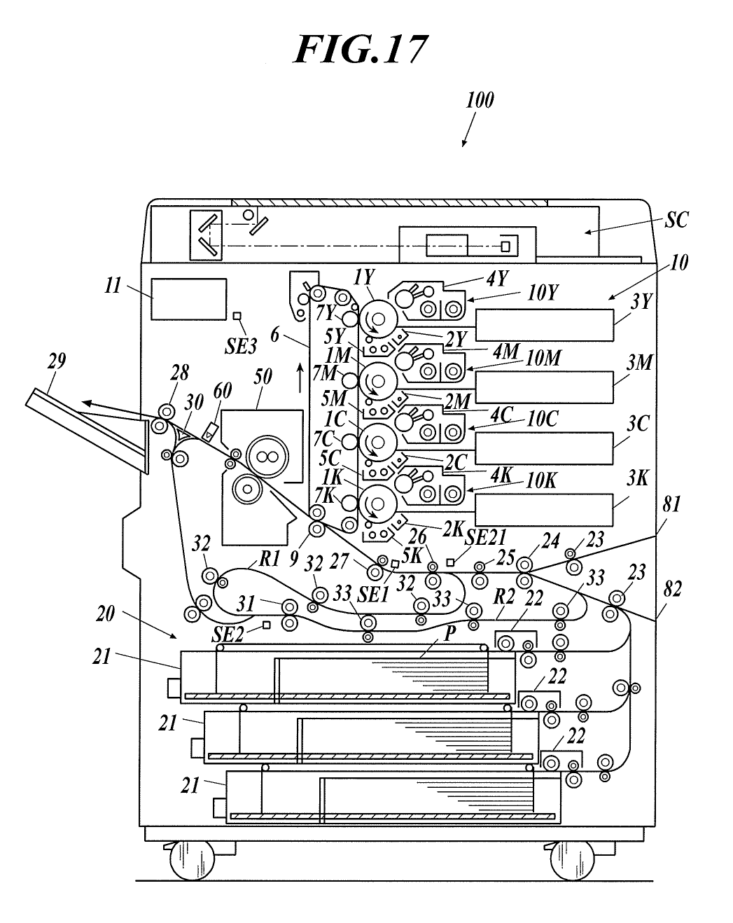

The above-described embodiments are examples in which the single position sensor SE2 is disposed only in the upstream of the flipping roller 31. However, the position sensor SE2 is not limited thereto. That is, it is only necessary that at least one position sensor SE2 is disposed in the second side path at the side facing the image side of the sheet P. For example, another position sensor SE21 may be disposed in addition to the above-described position sensor SE2 as illustrated in FIG. 17.

When two position sensors SE2, SE21 are used for controlling the swing of the resist roller 27 as described above, the swing operation may be determined based on either individual detection results or combination of two detection results. As used herein, the swing operation includes the swing amount, the swing direction and the swing speed.

When the swing operation is determined based on the individual detection results, the processing may be configured such that the resist roller 27 is swung based on a detection result of the position sensor SE2, and thereafter the resist roller 27 is further swung based on a detection result of the position sensor SE21.

When the swing operation is determined based on the combination of two detection results, the processing may be configured such that the skew (sub-scanning bow) of the sheet P is calculated, and the resist roller 27 is swung based on the calculated skew of the sheet P. The skew of the sheet P can be calculated by dividing “the difference in the sheet width direction between X1 and X2” by “the conveying distance between X1 and X2”, where X1, X2 are the coordinates in the sheet conveyance direction FD of two points where the position of the side end of the sheet is detected. By calculating the skew of the sheet P based on the two detection results, it is possible to reduce the number of detections of the position of the side end of the sheet P and thereby to improve the processing speed.

As described above, when the two position sensors SE2, SE21 are used for controlling the writing operation of the image forming units 10Y, 10M, 10C, 10K, the writing operation may be determined based on either the individual detection results or a combination of the two detection results.

For example, when the writing operation is determined based on the individual detection results, the processing may be configured such that the image forming units 10Y, 10M, 10C, 10K perform the writing operation based on the detection result of the position sensor SE2 first, and thereafter the image forming units 10Y, 10M, 10C, 10K perform the writing operation based on the detection result of the position sensor SE21.

When the writing operation is determined based on the combination of the two detection results, the processing may be configured such that the skew (sub-scanning bow) of the sheet P is calculated, and the writing operation of the image forming units 10Y, 10M, 10C, 10K is performed based on the calculated skew of the sheet P. The skew of the sheet P can be calculated by dividing “the difference in the sheet width direction between X1 and X2” by “the conveying distance between X1 and X2”, where X1, X2 are the coordinates in the sheet conveyance direction FD of two points where the position of the side end of the sheet is detected. By calculating the skew of the sheet P based on the two detection results, it is possible to reduce the number of detections of the position of the side end of the sheet P and thereby to improve the processing speed.

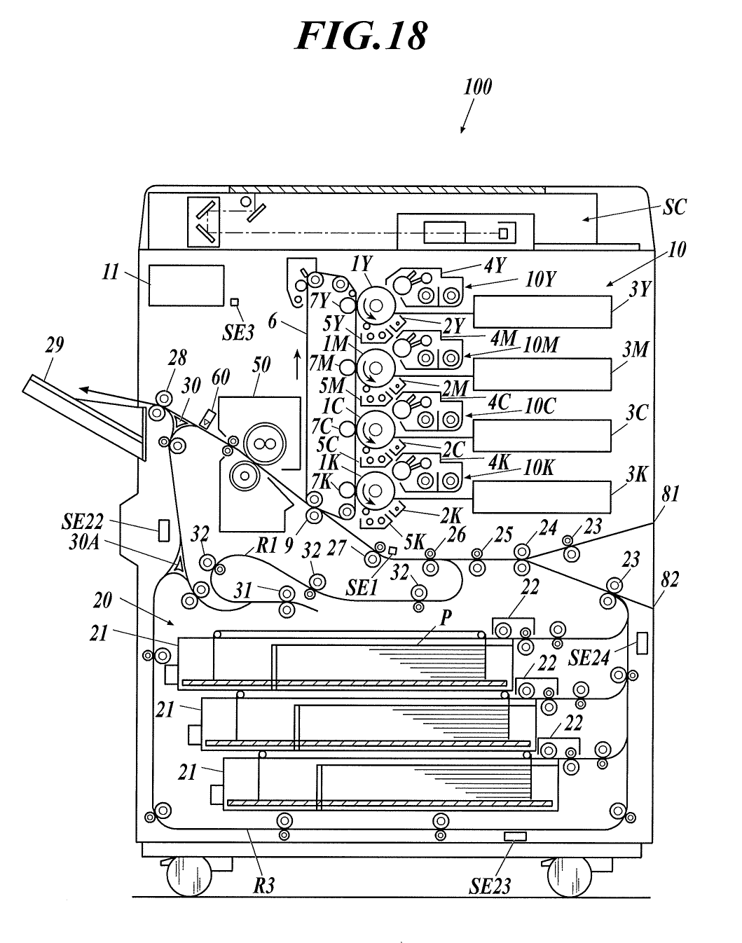

The above-described embodiments are examples in which the recirculation path R2 is disposed in the downstream in the sheet conveyance direction FD of the flipping roller 31. However, the configuration is not limited thereto. For example, as illustrated in FIG. 18, a switching gate 30A is disposed in the upstream in the sheet conveyance direction FD of the flipping roller 31 so that the sheet P is conveyed to either the path for forming another image on the back side of the sheet P (the flipping roller 31, the flipping path R1 and the like) or the path for overlaying another image on the front side of the sheet P (the recirculation path R3 and the like). FIG. 18 illustrates an example in which the recirculation path R3 is disposed under the feeding tray 21.

FIG. 18 also illustrates an example in which the position sensor SE2 is not provided in the vicinity (upstream) of the flipping roller 31. Instead, a position sensor SE22 is disposed in the upstream in the sheet conveyance direction FD of the switching gate 30A, a position sensor SE23 is disposed under the feeding tray 21, and a position sensor SE24 is disposed near the end of the recirculation path R3.

The position sensor SE22 disposed in the upstream in the sheet conveyance direction FD of the switching gate 30A can detect the position of the side end and the image information of the sheet P regardless of whether the sheet P is conveyed to the flipping path R1 or the recirculation path R3. Therefore, misalignment of the toner image with the sheet P due to sub-scanning bow can be reduced more surely.

The position sensor SE23 disposed under the feeding tray 21 is free from the influence of the temperature (heat) of the fixer 50 when it detects the sheet P or the like. Therefore, it can detect the side end and the image information of the sheet P with higher precision.

The position sensor SE24 disposed near the end of the recirculation path R3 can detect the side end and the image information of the sheet P in a position as close to the resist roller 27 as possible. Therefore, the misalignment of the toner image with the sheet P due to sub-scanning bow can be reduced with higher precision.

The above-described configuration is merely an example. Only any one or two of the position sensors SE22 to SE24 may be provided. Further, the above-described configuration may be combined with another configuration in which another position sensor is disposed in the second side path or the like.

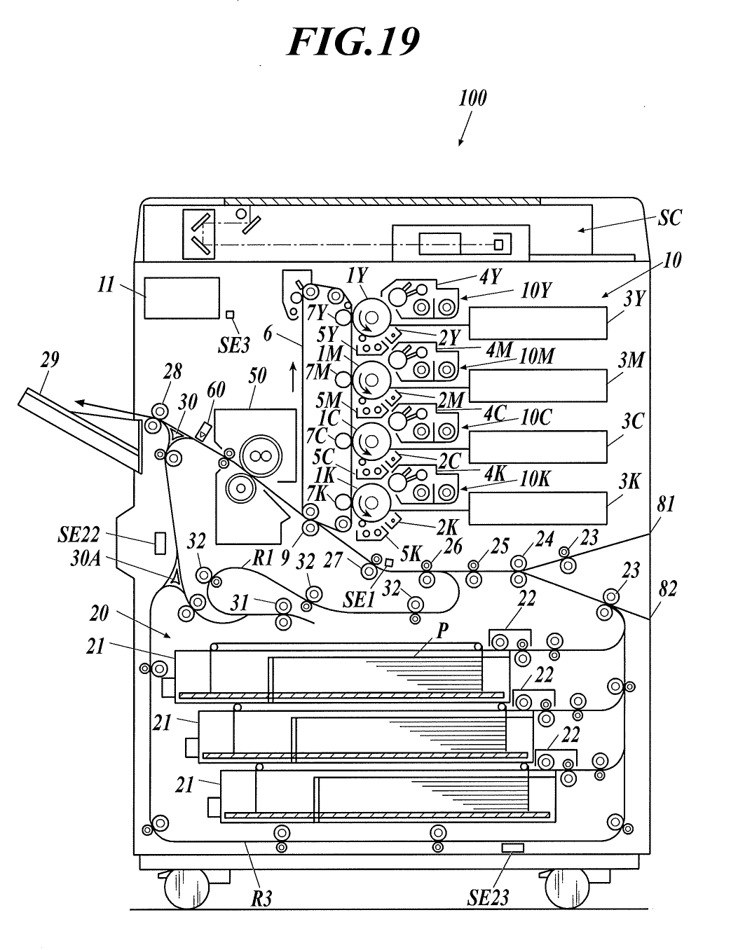

FIG. 19 illustrates an example in which the position sensor SE2 is not provided in the vicinity (upstream) of the flipping roller 31. Instead, a position sensor SE22 is disposed in the upstream in the sheet conveyance direction of the switching gate 30A, and a position sensor SE23 is disposed under the feeding tray 21.

The position sensor SE22 disposed in the upstream in the sheet conveyance direction FD of the switching gate 30A can detect the side end and the image information of the sheet P regardless of whether the sheet P is conveyed to the flipping path R1 or the recirculation path R3. Therefore, misalignment of the toner image with the sheet P due to sub-scanning bow can be reduced more surely.

The position sensor SE23 disposed under the feeding tray 21 is free from the influence of the temperature (heat) of the fixer 50 when it detects the sheet P or the like. Therefore, it can detect the side end and the image information of the sheet P with higher precision.

The above-described configuration is merely an example. Only any one of the position sensors SE22, SE23 may be provided. Further, the above-described configuration may be combined with another configuration in which another position sensor is disposed in the second side path or the like.

The correction value of the target position Tp of the sheet P does not necessarily correspond to the center of the image writing position. The target position Tp may indicate any position which allows forming the toner image in the optimal image position in the sheet P. That is, it is only necessary that the apparatus is configured to be able to form an image in the optimal image position of the sheet P when printing the image on the sheet P.

The shift amount of the image writing position We may not be necessarily determined based on the center of the image output position. It may be determined based on any position which allows forming the toner image in the optimal image position in the sheet P. That is, it is only necessary that the apparatus is configured to be able to form the image in the optimal image position of the sheet P when printing the image on the sheet P.

In the above-described embodiment, the swing of the resist roller 27 is controlled based on the detection results of the position sensor SE2 and the predetermined swing control information. However, the control is not limited thereto. For example, the image writing position of the image forming units 10Y, 10M, 10C, 10K may also be corrected (shifted) in addition to the swing control of the resist roller 27.

For example, the correction of the image writing position of the image forming units 10Y, 10M, 10C, 10K may be performed so that the absolute position of the image on the sheet P is corrected. Thereafter, the swing of the resist roller 27 may be controlled so that the positional error of the side end of the sheet P is reduced. This can reduce the swing amount of the resist roller 27 and thereby improve the durability of the resist roller 27.

The above-described embodiments are examples of color image forming apparatuses that transfer images from photoreceptor drums to an intermediate transfer roller by primary transfer and further transfer the images from the intermediate transfer roller to a sheet with a secondary transfer roller. However, the present invention is also applicable a monochrome image forming apparatus that directly transfers an image from a photoreceptor drum to a sheet with a transfer roller.

The above-described embodiments are examples in which the resist roller 27 swings in the sheet width direction CD. However, the resist roller 27 is not limited thereto. That is, instead of the sheet width direction CD, the resist roller 27 may swing in a different direction (e.g. in a direction of 5° apart from the sheet width direction CD) as long as it can move the conveyed sheet P in the sheet width direction.

The above-described embodiments are examples in which the swing roller is constituted by the resist roller 27. However, the swinging roller is not limited thereto and may be constituted by a different roller from the resist roller 27.

The above-described embodiments are examples of electrophotographic image forming apparatuses. However, the present invention is not limited thereto. For example, the present invention is also applicable to inkjet image forming apparatuses which record an image on a recording medium by ejecting ink from nozzles and landing them onto the recording medium in a desired pattern (e.g. inkjet recording apparatuses that eject ink curable by a predetermined energy beam from nozzles and irradiate the ink on the recording medium with the predetermined energy beam to cure it so as to fix the ink on the recording medium).

The above description illustrates examples in which a non-volatile memory, a hard disk or the like is used as a computer-readable medium for the program of the present invention. However, the computer-readable medium is not limited thereto. Other computer-readable media that can be used include portable recording media such as CD-ROM. A carrier wave is also applicable as the medium for providing data relating to the program according to the present invention through a communication line.

Suitable changes can be made without departing from the features of the present invention with regard to the detailed configuration and the detailed operation of the image forming apparatus.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent applications No. 2017-147402 and No. 2017-147404 filed on Jul. 31, 2017 and Japanese patent application No. 2017-148799 filed on Aug. 1, 2017 are incorporated herein by reference in their entirety.

What is claimed is:

1. An image forming apparatus which conveys a sheet to a transferring position of an image of a transferrer and transfers the image onto the sheet, comprising:
a swing roller comprising a pair of rollers which conveys the conveyed sheet toward the transferrer;
a detector which is disposed in a second side path at a side facing an image side of the sheet to detect a position of a side end of the sheet and image information of the image transferred on the sheet, in which the second side path is provided to form an image on a back side of the sheet or to overlay an image on a front side of the sheet; and
a hardware processor which swings the swing roller based on a detection result of the detector and predetermined swing control information.

2. The image forming apparatus according to claim 1,
wherein the second side path comprises a recirculation path for overlaying the image on the front side of the sheet.

3. The image forming apparatus according to claim 2,
wherein the recirculation path runs under a feeding tray which is disposed under the transferrer and a fixer, in which the fixer fixes the image on the sheet transferred by the transferrer.

4. The image forming apparatus according to claim 3,
wherein the detector is disposed under the feeding tray.

5. The image forming apparatus according to claim 1,
wherein the detector is disposed in an upstream of a flipping roller which guides the sheet to a flipping path for forming the image on the back side of the sheet.

6. An image forming apparatus which conveys a sheet to a transferring position of an image of a transferrer and transfers the image onto the sheet, comprising:
an image writer which writes the image;
a detector which is disposed in a second side path at a side facing an image side of the sheet to detect a position of a side end of the sheet and image information of the image transferred on the sheet, in which the second side path is provided to form an image on a back side of the sheet or to overlay an image on a front side of the sheet; and
a hardware processor which controls the image writer to write the image based on a detection result of the detector and a predetermined write control information.

7. The image forming apparatus according to claim 6,
wherein the second side path comprises a recirculation path for overlaying the image on the front side of the sheet.

8. The image forming apparatus according to claim 7,
wherein the recirculation path runs under a feeding tray which is disposed under the transferrer and a fixer, in which the fixer fixes the image on the sheet transferred by the transferrer.

9. The image forming apparatus according to claim 8,
wherein the detector is disposed under the feeding tray.

10. The image forming apparatus according to claim 6,
wherein the detector is disposed in an upstream of a flipping roller which guides the sheet to a flipping path for forming the image on the back side of the sheet.

11. An image forming apparatus, comprising:
a transferrer which transfers an image onto a sheet;
a fixer which fixes the image transferred by the transferrer on the sheet;
an image forming path for conveying the sheet to the transferrer and the fixer;
a swing roller which comprises a pair of rollers and which is disposed in the image forming path to convey the sheet toward the transferrer;
a flipping path which branches off from the image forming path in a downstream of the fixer in the image forming path and which is provided to flip the sheet with the image formed by the transferrer and the fixer on a first side and to re-feed the flipped sheet to the image forming path;
a detector which is disposed in the flipping path to detect a position of a side end of the sheet; and
a hardware processor which controls swing of the swing roller based on a detection result of the detector when the sheet re-fed from the flipping path is conveyed toward the transferrer.

12. The image forming apparatus according to claim 11,
wherein the flipping path comprises:
a first path which branches off from the image forming path and in which a flipping roller is disposed to convey the sheet in a certain direction and thereafter to rotate in a reverse direction so as to change the conveyance direction of the sheet; and
a second path which is disposed in a downstream of the first path in the conveyance direction of the sheet after the flipping roller changes the conveyance direction and which is provided to flip the sheet and to re-feed the flipped sheet to the image forming path,
wherein the detector is disposed in a downstream of the flipping roller in the conveyance direction of the sheet after the flipping roller changes the conveyance direction.

13. The image forming apparatus according to claim 11,
wherein the flipping path comprises:
a first path which branches off from the image forming path and in which a flipping roller is disposed to convey the sheet in a certain direction and thereafter to rotate in a reverse direction so as to change the conveyance direction of the sheet; and
a second path which is disposed in a downstream of the first path in the conveyance direction of the sheet after the flipping roller changes the conveyance direction and which is provided to flip the sheet and to re-feed the flipped sheet to the image forming path; and
a conveyance roller which is disposed in the second path to temporarily stop the sheet before re-feeding the sheet to the image forming path and thereafter to convey the sheet to the image forming path, and
wherein the detector is disposed in a downstream of the conveyance roller.

14. The image forming apparatus according to claim 11,
wherein the flipping path comprises:
a first path which branches off from the image forming path and in which a flipping roller is disposed to convey the sheet in a certain direction and thereafter to rotate in a reverse direction so as to change the conveyance direction of the sheet; and
a second path which is disposed in a downstream of the first path in the conveyance direction of the sheet after the flipping roller changes the conveyance direction, which comprises a bent portion for flipping the sheet and which is provided to flip the sheet at the bent portion and to re-feed the flipped sheet to the image forming path, and
wherein the detector is disposed at the bent portion, in a downstream of the bent portion or around the bent portion.

15. The image forming apparatus according to claim 11,
wherein the flipping path comprises:
a first path which branches off from the image forming path and in which a flipping roller is disposed to convey the sheet in a certain direction and thereafter to rotate in a reverse direction so as to change the conveyance direction of the sheet;
a second path which is disposed in a downstream of the first path in the conveyance direction of the sheet after the flipping roller changes the conveyance direction and which is provided to flip the sheet and to re-feed the flipped sheet to the image forming path; and
a joining path which re-joins the first path branched off from the image forming path to the image forming path, and
wherein the detector is disposed in the joining path.

16. The image forming apparatus according to claim 11,
wherein the detector is a plurality of detectors, and
wherein the hardware processor controls the swing of the swing roller based on the detection result of the plurality of detectors when the sheet re-fed from the flipping path is conveyed toward the transferrer.

17. The image forming apparatus according to claim 11,
wherein the hardware processor determines swing control information for the swing roller based on the detection result of the detector and controls the swing of the swing roller based on the determined swing control information.

18. The image forming apparatus according to claim 17,
wherein the detector is disposed at a side facing a side with the transferred image of the sheet and detects a position of a side end of the sheet and a position of the image on the sheet, and
wherein the hardware processor determines the swing control information based on the position of the side end of the sheet and the position of the image on the sheet detected by the detector.

19. The image forming apparatus according to claim 17,
wherein the hardware processor determines the swing control information further based on a sheet conveyance-related condition.

20. The image forming apparatus according to claim 17,
wherein the hardware processor determines the swing control information with respect to each of timings of swinging the swing roller based on the detection result of the detector.
